(19) United States
(12) Patent Application Publication
(10) Pub. No.: US 2005/0083782 A1
(43) Pub. Date: Apr. 21, 2005

(54) Agitator

(75) Inventors: Reinhold Gronau, Leverkusen (DE); Reinhold Rose, Leverkusen (DE); Thomas Herweg, Wipperfurth (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 10/964,368

(22) Filed: Oct. 13, 2004

(30) Foreign Application Priority Data
Oct. 15, 2003 (DE) 10347930.9

(51) Int. Cl. B01F 7/24

(52) U.S. Cl. 366/310; 366/320

(57) ABSTRACT

A straight-arm paddle agitator is described for processing viscous reaction mixtures in vessels with a low filling level. The straight-arm paddle agitator is made from at least one shaft with a drive means for the rotation of the shaft and with an agitating beam fitted terminally to the shaft and is characterized in that the ends of the agitating beam are each provided with a helical segment which is positioned at an angle of 25° to 65°, preferably 30° to 60°, in relation to the shaft axis.

### FIELD OF THE INVENTION

The invention relates to an agitator for rapid mixing of variably viscous co-reactants.

### BACKGROUND OF THE INVENTION

A large number of agitators for different mixing tasks are known in the art, for example anchor agitators or straight-arm paddle agitators.

A disadvantage of those anchor agitators or straight-arm paddle agitators is that at a very low filling level of the agitator vessel the agitator will no longer adequately mix the material to be mixed, for example a reactive polymerization mixture, and the material is merely displaced onto the wall of the vessel above the agitator.

With a view to miniaturization and automation for producing polyurethane foams for research purposes, an agitating station is needed that enables small samples of foamed material weighing 1 g to 100 g, in particular 1 g to 32 g, for example a maximum of 16 g, to be produced which provide results comparable to the classically produced 200 g to 300 g samples of foamed material. To this end, the foaming process takes place in an agitating beaker.

For the reproducible production of small quantities of polyurethane foams, suitable agitating conditions have to be created because the ratio of surface area to volume to be mixed becomes relatively large, because the components to be mixed (1 mg to 60 g, in particular 1 mg to 20 g per component) may exhibit great differences in viscosity (0.001 Pa·s to 500 Pa·s) and because the mixing-time of the reactive mixtures may be very short and may amount to at least 2 s, in particular at least 3 s.

In numerous laboratory experiments, various commercial agitators (e.g. straight-arm paddle agitators) have been employed which, however, do not satisfy all of the stipulated conditions.

### SUMMARY OF THE INVENTION

The present invention therefore provides an agitator that within a few seconds, amounting to at least 2 s, in particular at least 3 s, intermixes viscous co-reactants having a viscosity from 0.001 Pa·s to 500 Pa·s in vessels having a low filling level in the region of at least 1 mm, in particular at least 3 mm.

### BRIEF DESCRIPTION OF THE FIGURES

The present invention will now be described for purposes of illustration and not limitation in conjunction with the figures, wherein:

FIG. 1 shows a front view of an embodiment of the agitator according to the invention

FIG. 2 provides a side view of the agitator according to FIG. 1

FIG. 3 illustrates a top view of the agitator according to FIG. 1

### DETAILED DESCRIPTION OF THE INVENTION

The present invention will now be described for purposes of illustration and not limitation. Except in the operating examples, or where otherwise indicated, all numbers expressing quantities, percentages and so forth in the specification are to be understood as being modified in all instances by the term “about.” According to the invention, a straight-arm paddle agitator having at least one helical segment with a pitch angle in relation to the shaft axis is provided at each of the ends of the agitating paddles or beams.

The invention provides a straight-arm paddle agitator made from at least a shaft with a drive means for the rotation of the shaft and with an agitating beam fitted terminally to the shaft, the ends of the agitating beam each being provided with a helical segment which is positioned at an angle of 25° to 65°, preferably 30° to 60°, in relation to the shaft axis.

These helical segments are fitted in such a way as to have a conveying effect to the bottom of the mixing vessel in the course of rotation of the agitator.

In particularly preferred manner, the agitator exhibits two agitating beams, which in particular are arranged crosswise, with terminal helical segments.

Also preferred is an agitator wherein the width of the helical segments amounts to up to 10% of the outside diameter of the agitator.

In a preferred design, the helical segments are fitted to the agitating beam in such a way as to be connected to the agitating beam in the central region of their longitudinal extent. In this case, the upper half of the helical segment runs ahead of the agitating beam, whereas the lower half trails behind the agitating beam in its rotation.

In another particularly preferred embodiment, the helical segments are fastened to a fastening beam parallel to the agitating beam and above the agitating beam. They may be separably or inseparably connected to the fastening beam. In addition, the helical segments may be fitted to the fastening beam elastically, for example by means of springs. A greater stability of the agitator structure is brought about by this means.

The underside of the agitating beam and/or the outside of the helical segments is/are preferably provided with a scraping edge made of an elastomeric or thermoplastic synthetic material. The scraping edge is wall-sweeping or bottom-sweeping, so that small quantities of the components can be homogenized even with a low filling level in an agitating beaker.

The invention further provides an agitator arrangement combining a mixer according to the invention and a mixing vessel, both the underside of the agitating beam and the outside of the helical segments being constructed so as to be wall-sweeping with respect to the inner wall of the mixing vessel. In this case the underside of the agitating beam and also the outside of the helical segments are preferably provided with a scraping edge made of a thermoplastic synthetic material, e.g. polytetrafluoroethylene (“PTFE”), polyvinylidene fluoride (“PVDF”), perfluoroalkyoxy-polymers (“PFA”), or elastomeric synthetic material.

The agitator may be useful for mixing reactive material having components of differing viscosity within the range from 0.001 Pa·s to 500 Pa·s. In this connection the agitator has particular advantages in partially filled mixing vessels and mixes/homogenizes within the range of a few seconds, preferably of at least 2 s.

The invention will be elucidated in greater detail below on the basis of the Figures by means of an example which, however, does not constitute a limitation of the invention.

In general, laboratory formulations for polyurethane foams are prepared with product quantities from 200 g to 300 g. With these quantities, liquid-covering agitators of diverse geometry are employed. The use of bottom-sweeping and edge-sweeping agitators is not known in the art. Small product quantities cannot be homogenized with such agitators during the short mixing-time.

### EXAMPLE

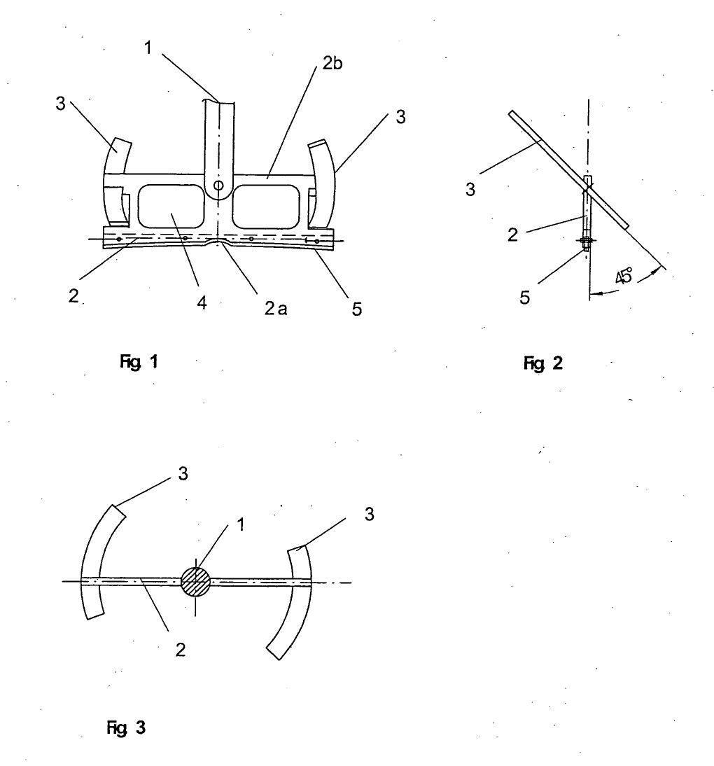

The agitator according to FIG. 1 exhibits an agitating beam 2 which is fastened to the lower end of the shaft 1. The agitating beam 2 is breached at two places 4. Attached by welding at the two ends of the agitating beam 2 are helical segments 3 which stand at an angle of 45° relative to the shaft axis 1 and to the agitating beam 2. In addition, a fastening beam 2b parallel to the agitating beam 2 is provided above the agitating beam 2.

The upper part of the segments 3 runs ahead of the agitating beam 2 in the course of rotation; the lower part trails behind said agitating beam, the upper part illustrated here being kept somewhat longer than the lower part of the helical segment 3.

The agitating vessel (not shown), which together with the agitator forms an agitating arrangement, exhibits in the middle of its bottom a raised gate mark. In order to adapt the agitator to the wall of the vessel, a corresponding recess 2a is provided in the middle of the agitating beam 2. The agitating beam 2 further exhibits a scraping edge 5 at its lower end facing towards the agitating vessel.

The wall-sweeping agitator is operated at a speed of up to 3500 min⁻¹ and conveys the components to be homogenized from the bottom into the peripheral zone of the agitating beaker. At the same time, the components at the edge of the agitating vessel are conveyed from top to bottom by the wall-sweeping helical segment 3. The ring of liquid arising in this way is homogenized with straight agitating beams 2 (or, in a form which is not drawn, with obliquely positioned agitating beams). The finished specimen of foamed material produced in this way has a uniform foam structure and streak-free peripheral zones.

An exemplary formulation has components with the following viscosities:

| | | | |
|---|---|---|---|
| Component 1: | 100 mg | viscosity: | about 0.001 Pa · s |
| Component 2: | 200 mg | viscosity: | about 0.001 Pa · s |
| Component 3: | 4900 mg | viscosity: | about 20 Pa · s |
| Component 4: | 2300 mg | viscosity: | about 400 Pa · s |
| Component 5: | 1100 mg | viscosity: | about 0.001 Pa · s |
| Component 6: | 7400 mg | viscosity: | about 0.4 Pa · s |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A straight-arm paddle agitator comprising:
a shaft with a drive means for the rotation of the shaft and with an agitating beam fitted terminally to the shaft,
wherein each end of the agitating beam is attached to a helical segment which is positioned at an angle of from about 25° to about 65°, in relation to the shaft's axis.

2. The agitator according to claim 1, wherein the agitator comprises two agitating beams, which are arranged crosswise, with the terminal helical segments.

3. The agitator according to claim 1, wherein the helical segments are fitted to the agitating beam in such a way as to be connected to the agitating beam in the central region of the helical segments' longitudinal extent.

4. The agitator according to claim 1, wherein the helical segments are fastened to a fastening beam parallel to the agitating beam and above the agitating beam.

5. The agitator according to claim 1, wherein the width of the helical segments is up to about 10% of the outside diameter of the agitator.

6. The agitator according to claim 1, wherein the underside of the agitating beam and/or the outside of the helical segments is/are provided with a scraping edge made of an elastomeric or thermoplastic synthetic material.

7. An agitator arrangement comprising an agitator according to claim 1 and a mixing vessel, wherein the underside of the agitating beam and the outside of the helical segments are wall-sweeping with respect to the inner wall of the mixing vessel.

8. The agitator according to claim 1, wherein the helical segment is positioned at an angle of from about 30° to about 60° in relation to the shaft axis.

9. The agitator according to claim 6, wherein the thermoplastic synthetic material is chosen from polytetrafluoroethylene (“PTFE”), polyvinylidene fluoride (“PVDF”) and perfluoroalkyoxy-polymers (“PFA”).
